(19) United States
(12) Patent Application Publication
(10) Pub. No.: US 2004/0225497 A1
(43) Pub. Date: Nov. 11, 2004

(54) Compressed yet quickly searchable digital textual data format

(76) Inventor: James Patrick Callahan, Santa Clara, CA (US)

Correspondence Address: James Patrick Callahan, 2841 Mauricia Avenue, Santa Clara, CA, 95051, US

(21) Appl. No.: 10/429,326

(22) Filed: May 5, 2003

(51) Int. Cl. G10L 15/26; G10L 15/00

(52) U.S. Cl. 704/235

(57) ABSTRACT

A data processing method is disclosed for storing and retrieving text. The method achieves a significant level of efficiency in compression over prior art without having to compress the token dictionary through an iterative tokenization of the text and tokens. A benefit of the uncompressed token dictionary is faster searches and decompression of tokenized text. To achieve faster searches, an index with a given text resolution for each unique word is created and added as an additional column element in the alphabetized word table. Since tokens consisting of multiple tokens populate the tokenized text, they are parsed to tokens that represent unique words before a search for a word or phrase is conducted. In a relatively large text such as a Bible, there could be a large number of tokens that consist of multiple tokens, which could take fair amount of time to parse. Therefore, the method includes a step of creating an additional index that is added as an additional column element in the alphabetized word table. The resulting invention enables high levels of compression and faster searches of text in documents.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to a method and algorithm to compress common textual data file formats used with computers such as text, hypertext markup language (“HTML”), and Extensible Markup Language (“XML”) files. The compressed data file is structured such that one or more words or phrases can be quickly searched for and the search results rapidly decompressed to the more common textual data file.

2. Description of the Related Art

With the prevalence of computers and Internet, we are witnessing a true explosion of information. Many algorithms have been developed to compress text, image, audio, and video effectively in order to reduce storage requirements. For textual data, known compression techniques include substitution of frequently used sequences of characters and words by tokens of shorter length. A table of tokens is used to encode and decode the tokenized text body. For example, U.S. Pat. No. 5,991,713 to Unger et al. discloses a method of token-based compression that utilizes a set of predetermined dictionaries along with a supplemental dictionary. He correctly points out the added benefits of tokenized compression for text data including the potential for fast searches without the decompression of an entire file and the ability to decompress only a portion of the file into a machine-readable format. On the other hand, citing the deficiencies of compression methods based on fixed (and predetermined) dictionaries, U.S. Pat. No. 5,999,949 to Crandall discloses a compression system that employs a main token dictionary and a common word token dictionary, both derived by assigning tokens to each unique word in the immediate text only. Since the size of the two dictionaries could negate the benefit of the compressed (tokenized) text, Crandall discloses a complex system that employs three compression techniques to reduce the size of the dictionaries.

Most token-based compression techniques share a common trait that if the text to be compressed is small in size, the compression achieved is negligible. And in some cases, the files size could actually increase upon tokenizing. Therefore, when considering a token-based compression method, it is useful to consider the impact of different procedures on the total size of the compressed file for files that are fairly large (at least several dozen pages of text). For example, in a fair-sized text such as a Bible, a straightforward tokenization would reduce the text size from about 4.5 Mbyte to about 2.2 Mbyte. In such a file, the uncompressed dictionary would be on the order of 75 Kbyte, about 3.5% of the total compressed file. Therefore, even a 90% compression on the dictionary results in reduction of about 3% of the total compressed file. Moreover, heavily compressed dictionary will cause delay in decompression and search speeds. Similarly even if a predetermined dictionary per Unger was able to account for 75% of different Bible versions, the resultant savings would amount to about 50 Kbyte and 100 Kbyte from files totaling about 4.4 Mbyte and 6.6 Mbyte for two and three Bibles respectively.

A key activity associated with textual data is searching for one or more words of interest from the body of text. As mentioned earlier with respect to U.S. Pat. No. 5,991,713, a search can be achieved at higher speeds by using tokens of a fixed size; scanning through a list of same-sized tokens for a query word that is tokenized proceeds quite fast. However, even with the higher speed, scanning through a large text file can be time consuming. A common method to speed up the searching of textual data is the usage of index. U.S. Pat. No. 5,099,426 to Carlgren et al. discloses a method that utilizes a lemma number-to-text location list to locate the section of compressed tokenized text to decompress and perform “fuzzy” comparison of query words to the decompressed text. In this case, the gain in search speed available by working with tokens was given up. However, the search for match in the decompressed text was done in only a small portion of the text identified by the index. These two approaches (with and without using an index) to search typify the tradeoff that is somewhat inherent between the file size and search speed.

### BRIEF SUMMARY OF THE INVENTION

The present invention discloses a data processing method for storing and retrieving text. The method achieves a significant level of efficiency in compression over prior art without having to compress the token dictionary through an iterative tokenization of the text. A benefit of the uncompressed dictionary is faster searches and decompression of tokenized text.

The method includes steps of assigning a 16-bit word identification number (WID) to each unique word in the text and building a word table (equivalent to a token dictionary). A further step is identifying frequently occurring WID pairs in the tokenized text and assigning double-word identification numbers (DWID). This process of assigning DWID continues with frequently occurring WID-DWID pairs, DWID-DWID pairs, and higher order pairs until no additional pairs occur frequently. After the iterative process, even a whole sentence, if it occurred frequently, will be represented by a single 16-bit DWID. The WID portion of the word table is alphabetized in order to facilitate quick decompression.

To aid fast searches, an index with a given text resolution for each unique word is created and added as the second column element in the alphabetized word table. Since DWIDs populate the tokenized text, they have to be parsed to WIDs before they can be searched. In a relatively large text such as a Bible, there could be as many as 25,000 DWIDs, which could take fair amount of time to parse. Therefore, the method includes a step of creating a DWID index that is added as the third column element in the alphabetized word table.

The resulting invention enables high levels of compression and faster searches of text in documents.

### BRIEF DESCRIPTION OF THE DRAWINGS

The invention is more fully described with reference to the accompanying figures and detailed description.

FIG. 1 is a high level flow chart that illustrates a method for compressing a file according to an embodiment of the present invention.

FIG. 2 depicts the assignment of tokens as the source text file is read into the computer.

FIG. 3 depicts the word table that has been ordered in an alphabetical manner and the associated tokenized text.

FIG. 4 depicts the iterative process of building double word tokens.

FIG. 5 depicts the process of assigning multi-word tokens.

FIG. 6 depicts the word table with indices for each unique word; these indices help to search and decompress tokenized text quickly.

FIG. 7 depicts the multi-word token table with indices for each unique word.

FIG. 8 is a high level flow chart that illustrates a method for searching the tokenized file for a word or a phrase according to an embodiment of the present invention.

FIG. 9 is a screen shot of a search result implemented in a handheld computer.

### DETAILED DESCRIPTION OF THE INVENTION

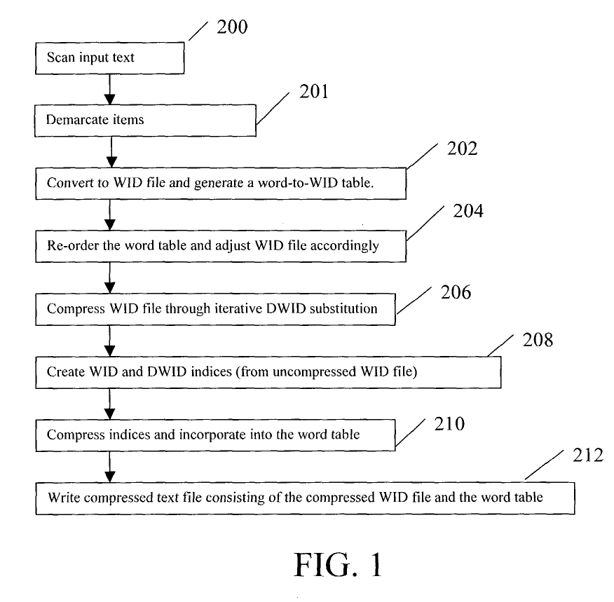

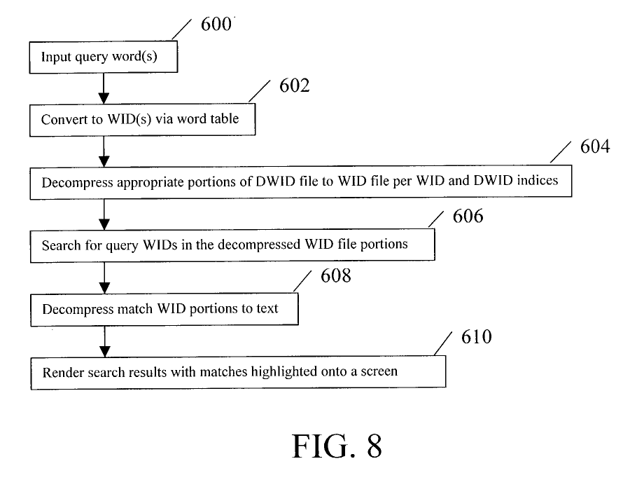

The invention will be explained in two parts. The first is how to effectively compress data so that it can be searched quickly and secondly how to actually perform such a search. FIG. 1 describes the high level steps followed in compressing the text file while FIG. 8 describes the high level steps followed in searching the compressed file.

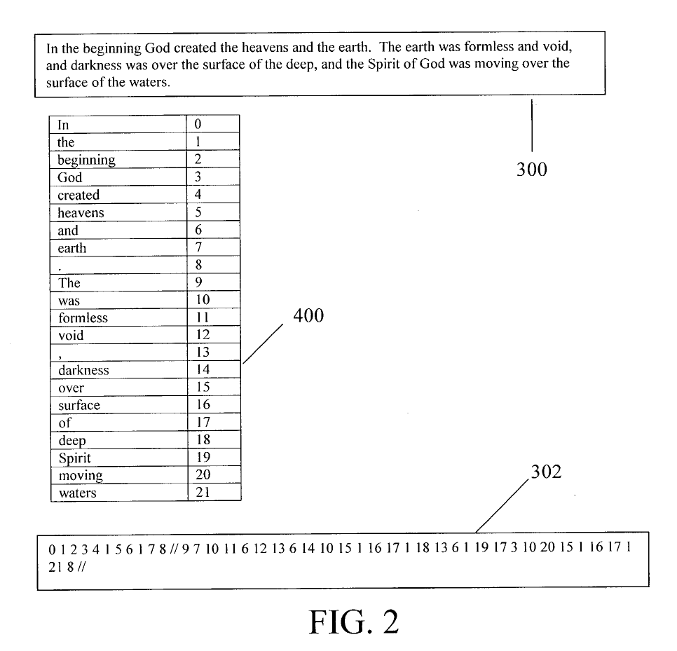

The first step in creating the compressed file is to break up the text into what we call items. Depending on the nature of the text to be compressed, an item can be a paragraph, a section, a text of fixed number of bytes, or other convenient chunk of text. The demarcation of the text into items can be performed manually by a human editor or automatically by the computer depending on the complexity and richness in the make-up of the text file. This step is described as step 201 in FIG. 1. The next step in creating the compressed file is to assign a 16-bit token to each unique word in the itemized text file and create a tokenized text file (TTF). The token could be of any bit length, but for most practical purposes, 16-bit tokens are sufficient. The result of the steps 201 and 202 in FIG. 1 is depicted in FIG. 2 for a sample text file 300 consisting of a few sentences. As the result of the step, the word-table 400 is created along with the tokenized text 302, where “/1” demarcates the end of each item. In most alphabet-based language representations, letters are commonly assigned 8 bit values. This is true of languages that have very small alphabets such as English (26 letters). Since the average length of a word is greater than two letters (thereby requiring more than 16 bits to describe itself), compression occurs. As mentioned, there are many prior arts describing this process. For medium to large files, the compression achieved by this process alone could be quite significant.

In the current example, each sentence constitutes an item. However as mentioned earlier, depending on the nature of the text to be compressed, an item can be a paragraph, a section, a text of fixed number of bytes, or other convenient chunk of text. The itemized nature of the tokenized text facilitates a meaningful de-compression (or reverse tokenization) of portion of the tokenized text. For example, there are 31,101 verses in the Bible. If each verse is treated as an item, any verse from any part of the Bible can be decompressed with ease without having to decompress the other parts of the tokenized Bible.

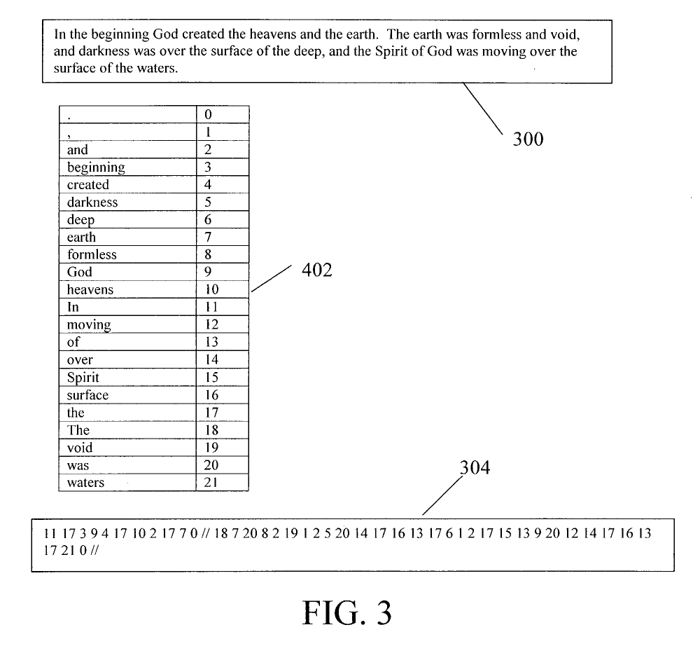

Once the entire text file has been converted to a tokenized text file (TTF), the next step 204 in the compression procedure (FIG. 1) is to alphabetize the word table 400 and re-tokenize the TTF according to the alphabetized word table 402. The newly tokenized TTF 304 along with the alphabetized word table 402 are shown in FIG. 3. The newly tokenized TTF 304 will be referred to as alphabetized TTF from now on. The alphabetized word table 402 allows the software to tokenize a query phrase more quickly, but is not essential for the compression to be effective. Note that at this stage, the word table 402 is a one-dimensional array with the token for each unique word being represented as the element position number of the array.

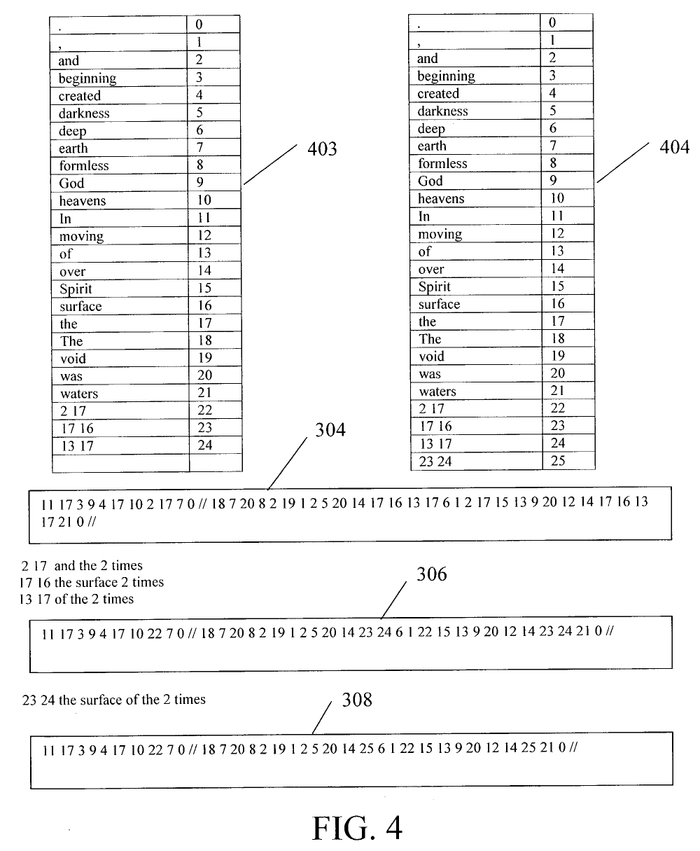

The next step 206 in the compression procedure (FIG. 1) is to perform a statistical analysis of the alphabetized tokenized text file (TTF) 304 for the frequency of WID (or token) sequences. In order to achieve maximal compression, the most frequently occurring sequences are each assigned a unique token. In order to differentiate the tokens associated with a unique word and a sequence of words, we coin the word WID and DWID for respective tokens. However, both WIDs and DWIDs are 16-bit tokens. FIG. 4 shows the process in a detailed manner. When the alphabetized TTF 304 is analyzed for a WID sequence, we find that there are three pairs of tokens ((2, 17), (17, 16), and (13, 17)) that occur twice. We then assign a new token to each of these three WID pairs as shown in the modified word table 403. We can now compress the TTF 304 further by utilizing the new DWIDs, resulting in the compressed TTF 306. We now iterate the process and find that there is a pair of tokens (23, 24) that occur twice. Note that these tokens are DWIDs. We then assign a new DWID to this pair of DWIDs as shown in the modified word table 404. We can now compress the once-compressed TTF 306 further by utilizing the new DWID, resulting in the compressed TTF 308.

In a large corpus a surprising number of word sequences occur so that this iterative DWID substitution results in great compression of the initial TTF 304. For a fairly large book such as a Bible, the initial TTF 304 is about 2.2 Mbyte in size as indicated earlier. After the iterative DWID substitution, the final TTF 308 could be as small as about 1.2 Mbyte.

As mentioned earlier, in order to achieve maximal compression, the most frequently occurring sequences are each assigned a unique token. In practice, all token-pairs that occur more than a threshold number are first assigned DWID tokens. Then the threshold number is lowered, and the token-pairs that occur more than the lowered threshold number are assigned DWID tokens. This process of lowering the threshold number and assigning DWID tokens is repeated until the threshold number reaches a set limit number. Therefore, a pair of tokens has to occur more than a certain limit number (N) of times for it to be assigned a DWID. In one preferred embodiment of the current invention, this limit parameter N is used as an input parameter while compressing a text file.

This iterative process of assigning DWIDs achieves the greatest compression but is somewhat time consuming. One way to compromise in the compression to gain speed is to assign DWIDs to all token-pairs that occur more than a specified limit number of times in one pass. Using the Bible as an example again, the full iterative process and a single pass process yielded a compressed file of about 1.2 Mbyte in 70 seconds and 1.4 Mbyte in 15 seconds respectively on our Pentium-III-based personal computer. Even this single pass process can be iterated one or more times until there is no more token-pairs that occur more than the specified limit number of times.

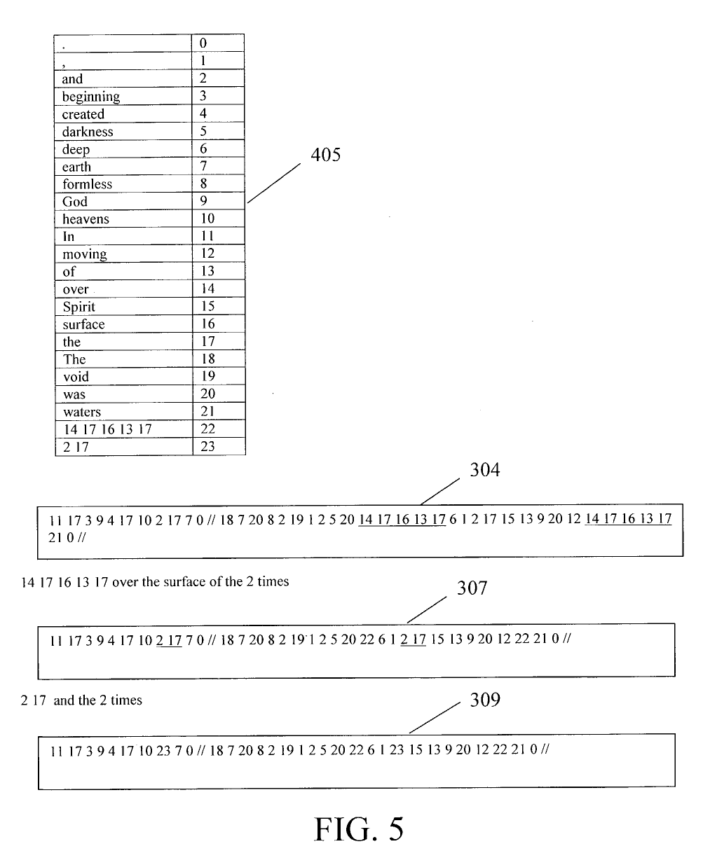

The DWID assignment steps described above further compressed the tokenized text file (TTF). A different method of compressing TTF is to assign multiple-word identification numbers (MWID). In this process, the alphabetized TTF 304 is analyzed to identify multiple-token sequences. For each multi-token sequence that occurs more than a certain limit number of times, it is assigned a 16-bit MWID. The assignment starts with the longest token sequence and works down the length of the sequence. This process is depicted in FIG. 5. In the alphabetized TTF 304, we see that the sequence (14, 17, 16, 13, 17) occurs twice. We assign a new token to this WID sequence as shown in the modified word table 405. We can now compress the TTF 304 further by utilizing the new MWID, resulting in the compressed TTF 307. We now iterate the process and find that the pair of tokens (2, 17) occurs twice. We then assign a new MWID to this pair of WIDs as shown in the modified word table 405. We can now compress the once-compressed TTF 307 further by utilizing the new MWID, resulting in the compressed TTF 309.

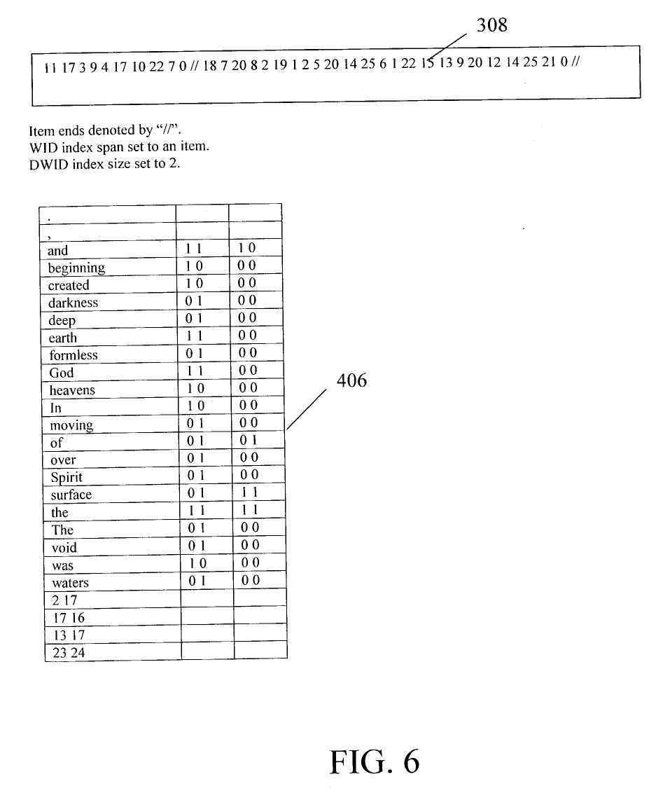

Once the compressed tokenized text file is created, the next step 208 in the compression procedure (FIG. 1) is to create indices for WID and DWIDs (or MWIDs). This procedure is depicted in FIG. 6. The alphabetized TTF 304 is used to identify the coarse location of each WID. In the example shown in FIG. 6, the WID index span is set at single item. To create the actual WID index, “1” is recorded for each index span that a given WID is present in, and “0” otherwise. Therefore in the example shown in FIG. 6, the token for “and” is present in both spans in the alphabetized TTF 304, resulting in “1, 1.” On the other hand, the WID for “beginning” is present only in the first span, resulting in “1, 0.” The process is repeated for each WID, and the WID index is added to the word table 404 as the second column. The resulting updated word table 406 is shown in FIG. 6. In one preferred embodiment of the current invention, a parameter Nw is used to control the size of WID index span for a given text file and used as an input parameter while compressing the file. For the example given above, the parameter Nw is such that single item constitutes an index span. The parameter Nw could have been chosen such that two items constitute an index span in which case the second column in the updated word table 406 would have contained a single number 1 for all unique words. Though the index span of two segments is meaningless in the case of our specific example, it and even an index span of many items are relevant for large text files. The use of this sparse WID index eliminates the need to scan the whole corpus (a significant time saver with a large corpus) at the time of keyword search. For instance, in a corpus such as the Bible, the word Jesus is known not to occur in the first two thirds of the text.

In another embodiment of the invention, a non-linear distribution of the index span is used. For example, if a portion of a book is searched for more frequently, the size of index span for that portion can be decreased while the size of index span for the rest of the book can be increased.

The next index to be created is the DWID index. To create the DWID index size M, the entire DWIDs are first arranged as a sequence of groups of M sequential DWIDs per group. In the example shown in FIG. 6, the DWID index size is set at 2. That means the four DWIDs shown in the word table 404 are grouped into two groups, (22, 23) and (24, 25). To create the actual DWID index, “1” is recorded for each DWID index group that a given WID is present in, and “0” otherwise. Therefore in the example shown in FIG. 6, the WID for “and” is present in the first group that consists of 22 and 23, resulting in “1, 0.” On the other hand, the WID for “beginning” is not a part of any DWID, resulting in “0, 0.” However, the WID for “surface” is present in both DWID index groups, resulting in “1, 1.” The process is repeated for each WID, and the DWID index is added to the word table 404 as the third column. The resulting updated word table 406 is shown in FIG. 6. In one preferred embodiment of the current invention, the DWID index size M is used as an input parameter while compressing the file. The DWID index is used to quickly decompress the DWIDs into WIDs for relevant sections of the compressed TTF 308 during search and rendering of the text. Since both the WID and DWID indices are sparse, they are readily run-length-encode compressed, increasing the total file size only moderately. Again using the Bible as an example, the fully compressed file consisting of the compressed TTF 308 and the modified word table 406 range from 1.275 Mbyte to 1.45 Mbyte depending on the parameters N, Nw, and M. The smaller file has only a minimal amount of indices while the larger file has more extensive indices. Accordingly, the search speed for the larger file size is much faster than that for the smaller file size.

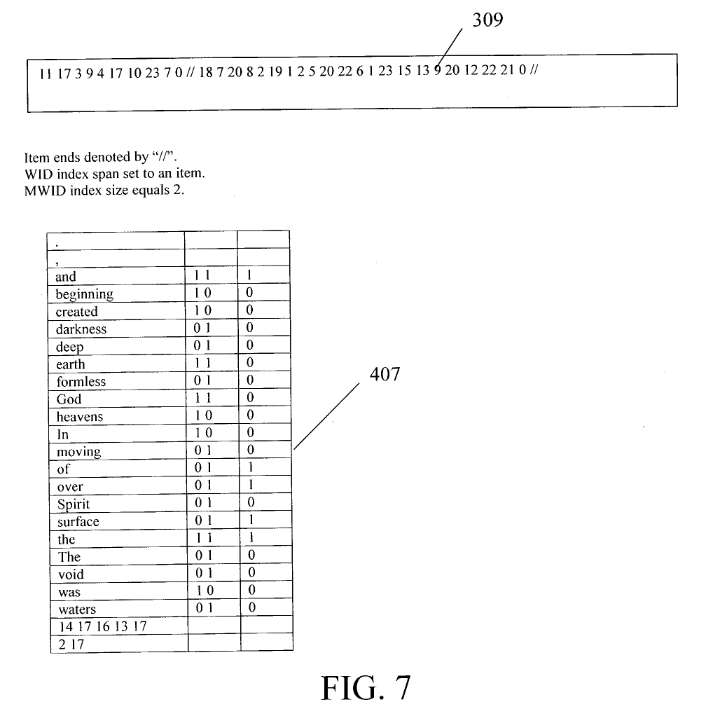

FIG. 7 depicts the assignment of WID and MWID indices for TTF that was compressed using MWIDs. The assignment of the WID index is identical as in the case of DWID compressed TTF. The WID index is added to the word table 405 as the second column, shown in FIG. 7 as an updated word table 407. For MWID index, the process is similar as well. First, the entire MWIDs are first arranged as a sequence of groups of X sequential MWIDs per group. In the example shown in FIG. 7, the MWID index size is set at 2. That means the two MWIDs shown in the word table 405 are grouped into a single group, (22, 23). To create the actual MWID index, “1” is recorded for each MWID index group that a given WID is present in, and “0” otherwise. Therefore in the example shown in FIG. 7, the WID for “and” is present in the group, resulting in “1.” On the other hand, the WID for “beginning” is not a part of any MWID, resulting in “0.” The process is repeated for each WID, and the MWID index is added to the word table 405 as the third column. The resulting updated word table 407 is shown in FIG. 7. In one preferred embodiment of the current invention, the MWID index size X is used as an input parameter while compressing the file. The MWID index is used to quickly decompress the MWIDs into WIDs for relevant sections of the compressed TTF 309 during search and rendering of the text. In very large corpuses containing many words, the 65,635 unique 16-bit tokens can be exhausted. In this case the corpus is segmented, that is, broken up into smaller corpuses, each corpus containing less than 65,635 unique 16-bit tokens.

The final step 212 in FIG. 1 in creating the compressed file is to write out to a harddisk, a flash memory device, or other storage medium the compressed text file that consists of the compressed TTF 308 (or 309) and the final word table 406 (or 407).

How searches can be performed quickly on such WID-DWID compressed text will now be explained (FIG. 8); the search process for WID-MWID-compressed text is virtually identical and will be skipped. A user initiates a keyword search by entering query words (step 600 in FIG. 8) that represent topics of interest. This scenario is well known to those who use popular web search engines. These words are then mapped to their WIDs (step 602) through the use of the word table. In one embodiment of the invention, this process takes a minimal amount of time since the word table is sorted and not compressed. Next the appropriate DWIDs (through the use of DWID index) of the appropriate sections (through the use of WID index) of the compressed TTF 308 are decompressed into compressed text 304 sections that consist only of applicable WIDs (step 604). These WIDs can now be linearly scanned for the 16 bit values of interest (step 606). Those that match the query words are decompressed into text (step 608) and rendered onto the computer screen (step 610) with the match highlighted. Great speed is attained since more text can be kept in the computer's memory due to its compressed nature and since no or less hard drive access is required. Since the clock rate of common modem CPU's is nearly 1 GHz, large quantities of text can be scanned very quickly when hard drive need not be accessed.

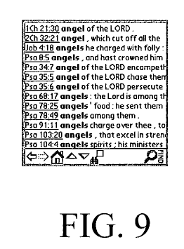

During the search process, it is somewhat straightforward to add more versatility and intelligence by stemming the query words to its root forms and identifying all derivatives of the root forms in the word table for the search operation. Even without a specialized stemming dictionary, many of the words derived from the same root are identifiable using a set of rules. For example, by using a rule for forming plurals of a noun, if the query word happens to be “angel” while the text contains both “angel” and “angels,” the tokens for both words (occurring most likely side by side in the word table) can be used to search the compressed file. A screen shot of such a search result is shown in FIG. 9. With the help of a stemming dictionary or other dictionaries, the scope of the intelligent search could be further increased; the dictionaries will expand the query tokens to beyond what the user actually typed in to include other related tokens. By using the expanded query tokens in searching the compressed file, a more comprehensive search can be performed.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

We claim:

1. A method for compressing text into a compressed file, comprising the steps of:
demarcating text in an input file into items;
parsing words from items;
assigning a word identification number to each unique parsed word;
maintaining a word table that relates a parsed word to the assigned word identification number;
creating a tokenized text with item demarcations of said input file by replacing parsed words with said word identification numbers;
assigning a double-word identification number to each unique token pair whose occurrence in the tokenized text is greater than a predetermined threshold number;
appending the token pairs with associated double-word identification numbers to the word table;
creating a compressed tokenized text by replacing pertinent token pairs in the tokenized text with corresponding double-word identification numbers;
lowering said threshold number by a predetermined value;
repeating the previous four steps with said compressed tokenized text until said threshold number reaches a predetermined limit number;
outputting a compressed file including said word table and said compressed tokenized text.

2. The method of claim 1 wherein a human editor performs said demarcation of text into items manually.

3. The method of claim 1 wherein said demarcation of text into items is performed according to a set of rules by the computer without a human editor.

4. The method of claim 1 further comprising the steps of:
dividing the uncompressed tokenized text into sequential sections of a fixed size;
creating a word index for each word in the word table by assigning a fixed value for said sections that contain the associated token for the word and another fixed value otherwise;
associating said word index to each word in the word table.

5. The method of claim 4 wherein said index is compressed via run-length-encoding.

6. The method of claim 4 wherein said sequential sections are of varying sizes.

7. The method of claim 1 further comprising the steps of:
dividing the token pairs, each pair of which is represented by a new token, in said word table into sequential groups consisting of a predetermined number of token pairs;
creating a double-word index for each word in said word table by assigning a fixed value for said group that contain the associated token for the word and another fixed value otherwise;
associating said double-word index to each word in the word table.

8. The method of claim 7 wherein said index is compressed via run-length-encoding.

9. The method of claim 1 further comprising the steps of:
performing a rule-based sorting of said word table;
assigning new sequential word identification numbers to the sorted words;
re-creating the tokenized text with the updated word identification numbers.

10. The method of claim 1, which further comprises the method of searching said compressed file, comprising the steps of:
inputting a query word;
converting said query word into the corresponding token by using said word table;
identifying the segments of said compressed tokenized file that contain said query token by using said word index;
identifying the multi-word tokens that contain said query token by using said multi-word index;
decompressing said identified multi-word tokens occurring in said identified text segments into single-word tokens;
identifying exact locations where said query token occur by scanning said single-word token segments;
decompressing said locations to form corresponding text portions of said text file

11. A method for compressing text into a compressed file, comprising the steps of:
demarcating text in an input file into items;
parsing words from items;
assigning a word identification number to each unique parsed word;
maintaining a word table that relates a parsed word to the assigned word identification number;
creating a tokenized text with item demarcations of said input file by replacing parsed words with said word identification numbers;
assigning a unique multi-word identification number to each token sequences consisting of the largest number of tokens and occurring more times than a predetermined limit number;
appending said token sequences with said multi-word identification numbers to said word table;
creating a compressed tokenized text by replacing said token sequences in the tokenized text with said multi-word identification numbers;
repeating the previous three steps with said compressed tokenized text until said token sequence consists of two tokens;
outputting a compressed file including said word table and said compressed tokenized text.

12. The method of claim 11 wherein a human editor performs said demarcation of text into items manually.

13. The method of claim 11 wherein said demarcation of text into items is performed according to a set of rules by the computer without a human editor.

14. The method of claim 11 further comprising the steps of:
dividing the uncompressed tokenized text into sequential sections of a fixed size;
creating a word index for each word in the word table by assigning a fixed value for said sections that contain the associated token for the word and another fixed value otherwise;
associating said word index to each word in the word table.

15. The method of claim 14 wherein said index is compressed via run-length-encoding.

16. The method of claim 14 wherein said sequential sections are of varying sizes.

17. The method of claim 11 further comprising the steps of:
dividing the sequences of tokens, each sequence of which is represented by a new token, in said word table into sequential groups, each group consisting of a predetermined number of token sequences;
creating a multi-word index for each word in said word table by assigning a fixed value for said group that contain the associated token for the word and another fixed value otherwise;
associating said multi-word index to each word in the word table.

18. The method of claim 17 wherein said index is compressed via run-length-encoding.

19. The method of claim 11 further comprising the steps of:
performing a rule-based sorting of said word table;
assigning new sequential word identification numbers to the sorted words;
re-creating the tokenized text with the updated word identification numbers.

20. The method of claim 11, which further comprises the method of searching said compressed file, comprising the steps of:
inputting a query word;
converting said query word into the corresponding token by using said word table;
identifying the segments of said compressed tokenized file that contain said query token by using said word index;
identifying the multi-word tokens that contain said query token by using said multi-word index;
decompressing said identified multi-word tokens occurring in said identified text segments into single-word tokens;
identifying exact locations where said query token occur by scanning said single-word token segments;
decompressing said locations to form corresponding text portions of said text file.
